(19) United States
(12) Patent Application Publication
(10) Pub. No.: US 2007/0044515 A1
(43) Pub. Date: Mar. 1, 2007

(54) Process of manufacturing a gob

(76) Inventor: Frank Pfeiffer, Gruenenplan (DE)

Correspondence Address: HARNESS, DICKEY & PIERCE, P.L.C., P.O. BOX 828, BLOOMFIELD HILLS, MI, 48303, US

(21) Appl. No.: 11/507,822

(22) Filed: Aug. 22, 2006

(30) Foreign Application Priority Data
Aug. 26, 2005 (DE) 10 2005 041 033.2

(51) Int. Cl. C03B 11/00; C03B 17/00

(52) U.S. Cl. 65/66; 65/127

(57) ABSTRACT

A process for manufacturing a gob as a primary product for pressing a pressed glass product for optical applications comprises filling a glass melt from a feeder into a casting mold having a substantially cylindrical shape, wherein the mold is made of an oxidation resistant material being substantially resistant against the glass melt and substantially free of sticking, wherein the glass melt is cut off by means of glass scissors for portioning a gob, the gob is cooled thereafter and removed from the mold so as to yield a gob having a fire-polished front face and a peripheral surface formed by a contact with the mold and being suitable for finish-pressing a pressed glass product for optical applications.

### BACKGROUND OF THE INVENTION

The invention relates to a process of manufacturing a glass gob configured as a primary product for pressing a glass product for optical applications, wherein initially a glass melt is filled from a feeder into a mold, wherein the glass melt is cut off by means of glass scissors for portioning a gob, the gob is cooled thereafter and removed from the mold.

Such a process is known from U.S. Pat. No. 5,738,701.

Herein a gob is filled from a feeder into a mold the shape of which is approximated to a pressed lens to be made therefrom. The mold that is used is made of a ceramic, a hard metal alloy, carbon or a metal.

For the later manufacture of a pressed lens from a gob the fire-polished surface arranged remote from the mold is used as a reference surface which is supposed to have no marks from the glass scissors used for cutting off.

According to US 2003/0211929 A1 initially spherical gobs are made which thereafter are used for manufacturing pressed glass products within a press mold made of SiC.

According to JP 55-062815 A (Patent Abstracts of Japan) from the glass melt initially substantially cone shaped gobs are made, which for finish-pressing are transferred to a pressing device by a suction device acting on its surface.

A manufacture of various pressed glass products, such as e.g. lenses, micro-lenses, micro-lens-arrays, from gobs is known from US 2004/0079114 A1. To this end disc-shaped or block-shaped gobs are used.

However, the known solutions have shown that usually on the fire-polished side a scissors mark is present resulting from cutting off the gob from the glass melt.

Thus, for pressed glass products of very high quality it is often necessary to initially perform a grinding operation on the gob at the side of the later finish-pressing, to yield a sufficiently high-quality starting surface for the finish-pressing. Naturally, such a grinding treatment is tedious and expensive.

### SUMMARY OF THE INVENTION

Thus it is a first object of the invention to disclose a method of manufacturing a gob which allows to manufacture pressed glass products of high quality suitable for optical applications, without performing grinding operations on the gobs.

It is a second object of the invention to disclose a method of finish-pressing a pressed glass product from a glass gob which is simple and cost-effective.

It is a third object of the invention to disclose a method of finish-pressing a pressed glass product from a glass gob which allows to make a high-quality pressed glass product suitable for optical applications.

These and other objects of the invention are solved by a process for manufacturing a gob configured as a primary product for pressing a pressed glass product for optical applications, wherein initially a glass melt is filled from a feeder into a mold having a substantially cylindrical shape, wherein the mold is made of an oxidation resistant material being substantially resistant against a glass melt and substantially free of sticking, wherein the glass melt is cut off by means of glass scissors for portioning a gob, the gob is cooled thereafter and removed from the mold so as to yield a gob having a fire-polished front face and a peripheral surface formed by a contact with the mold and being suitable for optical applications.

The object of the invention is fully achieved in this way.

Namely, according to the invention a gob is manufactured which, by contrast to the approach common in the prior art, comprises a high quality peripheral surface suitable for finish-pressing. This in particular is ensured by using an oxidation resistant material, substantially resistant to glass and without a tendency to sticking, for making the mold for manufacturing the gob.

With the gob made according to the invention the mark of the glass scissors that is always produced on the fire-polished front face when making the gob, is transferred from the location of the finish-pressing to the side. Thus, an implication detrimental to the quality of the finish-pressed surface can be avoided. Thereby a manufacture of high-quality pressed glass products is made possible, without previously performing a grinding treatment on the surface of the gob which is used for finish-pressing.

The mold for manufacturing the gob is substantially cylindrical according to the invention. In this way a particularly simple and cost-effective mold can be used for making the gob, which mold can be processed at its inner surface in a relatively simple and cost-effective way yielding a high surface quality, to ensure a respectively high surface quality of the gob made therein, without performing any finish-treatment.

According to a further embodiment of the invention the glass melt is filled into a cylindrical mold having a flattening at one inner surface thereof.

In this way, the gob can be correctly positioned within a press mold lying on the flattening of its peripheral surface.

According to a further development of the invention the glass melt is filled into a mold made of titanium.

Such a press mold can be made in a relatively simple way, but still has a very high stability against a glass melt and a very low tendency to sticking.

According to a further development of the invention the glass melt is filled into a mold which is made from a non-oxide ceramic.

Preferably the mold is made of a carbide ceramic, particularly preferred from a carbide ceramic which is selected from the group formed by a silicon carbide ceramic, a boron carbide ceramic and a tungsten carbide ceramic.

Thus, an easy removal of the gob from the mold is ensured and at the same time it is guaranteed that the mold is practically not subject to any wear.

Thus, a very high quality surface of the gob can be reached in the region of its peripheral surface.

As far as the mold is made of titanium, it can be prepared by a metal cutting process, such as by turning or milling respectively, and by subsequent grinding to the final dimensions.

This allows for a particularly simple and cost-effective manufacture.

As far as the mold is made of ceramic, the mold is preferably made by a sintering process. In the case of a silicon carbide ceramic also an infiltration process may be used. After the preparation by sintering or infiltrating the respective mold usually is ground to its final dimensions using a grinding treatment.

According to another preferred embodiment of the invention, the mold is dimensioned in such a way and the activation of the glass scissors is controlled in such a way that a gob is formed having a height-to-diameter-ratio between 0.3 and 3, preferably in the range of 0.5 to 2, more preferably between 0.8 and 1.25, mostly preferred between 0.9 and 1.1.

By using such a gob a particularly advantageous pressing behavior during finish-pressing the gob at its peripheral surface is reached, since the flow paths are minimized.

Also in this way a very even glass flow results for the total finish-pressed region, whereby the quality of the finish-pressed surface is further enhanced.

When preparing a pressed glass product from a gob made according to the invention, preferably the gob is placed within a press mold lying on its peripheral surface, without initially performing a grinding treatment, and is finish-pressed thereafter.

In this way a very high quality pressed glass product avoiding marks of scissors can be made in a cost-effective way.

Herein the gob preferably is placed within the press mold lying on a flattening of its peripheral surface.

In this way a correct positioning is ensured.

Herein the gob may be finish-pressed at its top side, at its bottom side or at both sides.

According to the invention this is made possible without any loss of quality, since the marks from the glass scissors are transferred into the lateral region.

It will be understood that the features mentioned before and to be disclosed hereinafter cannot only be used in the combination respectively given, but also in different combinations or on its own, without going beyond the scope of the invention.

### BRIEF DESCRIPTION OF THE DRAWINGS

Further features and advantages of the invention can be seen from the subsequent description of a preferred embodiment with respect to the drawings. In the drawings show:

FIG. 1 a schematic representation of feeding a mold from a feeder for manufacturing a gob;

FIG. 2 a perspective view of an exemplary pressed glass product prepared by the process according to the invention;

FIG. 3 a cross-sectional representation of a press mold according to the invention, wherein a gob having a ground surface is used for preparing the pressed glass product; and

FIG. 4 a cross-sectional representation of a mold for preparing a pressed glass product according to FIG. 2, wherein a gob according to the invention is placed within a press mold resting on its peripheral surface.

### DETAILED DESCRIPTION OF THE PREFERRED EMBODIMENT

In FIG. 1 a feeder 10 holding a glass melt 12 is shown schematically.

A glass melt can emerge from the feeder 10 via a bottom outlet opening 14 into a mold 18 placed thereunder. Herein a suitable portioning is performed by using glass scissors 16. If in this way a gob is filled into the mold 18, then for instance a cylindrical gob having a fire-polished surface (front surface) results, however, the front surface always bears marks from the glass scissors used.

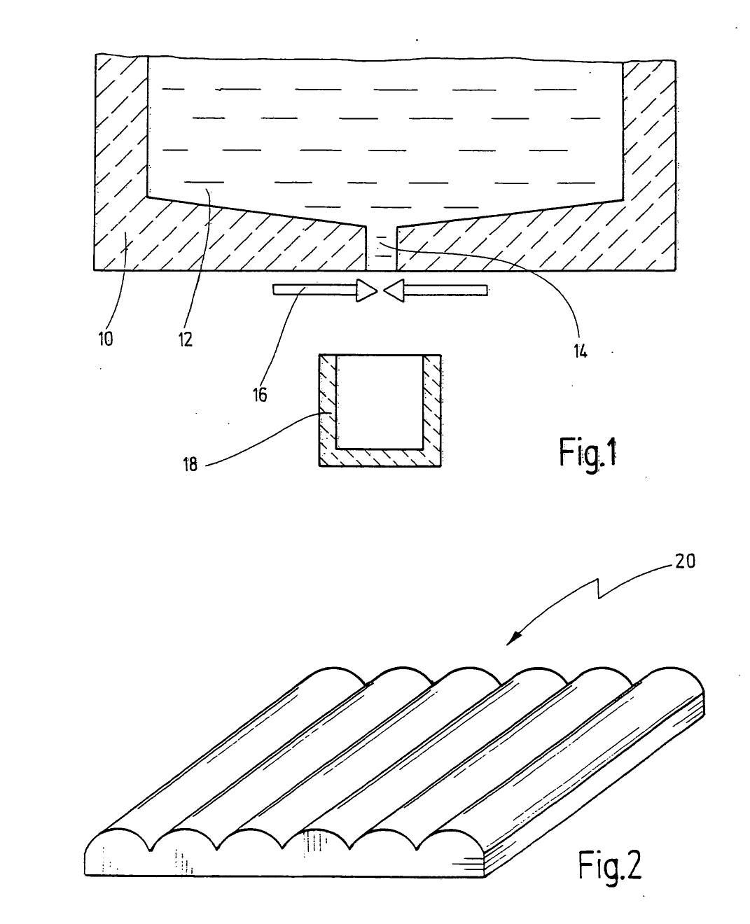

Such gobs are used e.g. for manufacturing optically high-quality pressed glass products for optical applications, such as shown in FIG. 2 and denoted with numeral 20 for merely exemplary purpose. Such a pressed glass product may e.g. be a cylinder lens array, such as known from US 2004/0079114 A1.

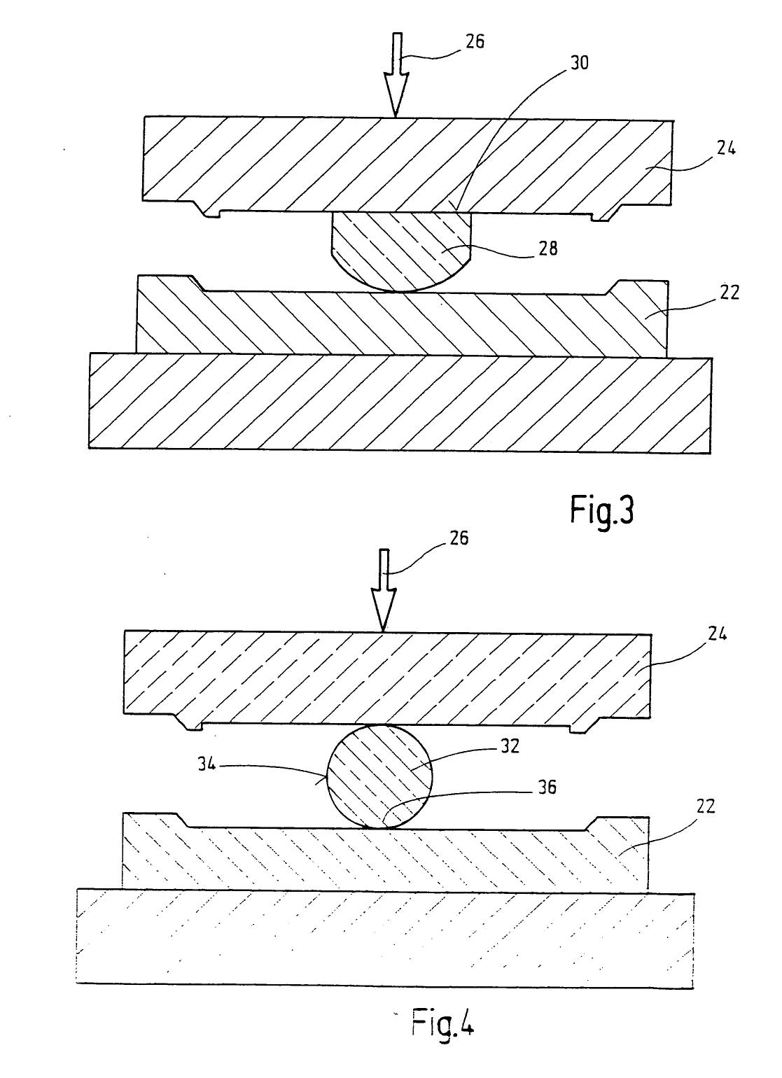

FIG. 3 shows the manufacture of such a pressed glass product accord-ing to the state of the art.

To this end, a press mold is used having a lower press mold half 22 and an upper press mold half 24. A gob 28 is used which is shaped convexly at it lower side, followed by a cylindrical shape which is ground at its top surface 30. The convex shape of the lower side is utilized to minimize the contact time between the glass and the press mold.

According to the state of the art a ground surface is necessary on the side of the finish-pressing to ensure a sufficiently high surface quality on the side of the finish-pressing.

During the pressing process the gob 28 is heated between the two mold halves 22, 24 up to a temperature sufficiently above the glass transformation temperature, and is subsequently pressed into the final shape (see e.g. FIG. 2) by moving the two mold halves 22, 24 against each other.

According to the method according to the invention shown schematically in FIG. 4, a considerable simplification and considerable cost savings are achieved when compared with the prior art process, also at the same time a consistently high surface quality is ensured on the finish-pressed side (top surface of the pressed product 20 according to FIG. 2).

To this end a gob 32 is utilized (see FIG. 4) having a cylindrical shape and being placed within the press mold 22, 24 resting on its peripheral surface 34. To facilitate a correct positioning of the gob 32 within the center of the press mold, the gob 32 comprises a narrow flattening 36 within the region of its peripheral surface 34. In this way a rolling away is avoided after placing within the press mold. The gob is prepared by feeding from a feeder 10 into a mold 18 using glass scissors 16, as shown schematically in FIG. 1.

To ensure a particularly high-quality peripheral surface 34 and to guarantee a safe removal from the mold 18 after cooling, the mold 18, which is used, is made of an oxidation resistant material which is substantially resistant against a glass melt, preferably a material is used which is made of a non-oxide ceramic, such as a carbide ceramic, e.g. a silicon carbide ceramic, a boron carbide ceramic or a tungsten carbide ceramic.

In particular, a preparation from titanium or silicon carbide ensures an easy removal from the mold without any sticking, due to its stability against a glass melt. Also titanium as well as silicon carbide can be prepared and processed in a cost-effective way.

According to the invention a grinding treatment of the gobs that are utilize for manufacturing the pressed glass products is not necessary.

What is claimed is:

1. A process for manufacturing a glass gob configured as a primary product for pressing a pressed glass product for optical applications, comprising the steps of:
providing a molten glass within a feeder;
providing a casting mold having a substantially cylindrical shape and made of an oxidation resistant material being substantially resistant against a glass melt and substantially free of sticking when in contact with a glass melt;
feeding a glass melt from said feeder into said casting mold;
cutting off the glass melt by means of glass scissors for portioning a gob within said casting mold, said gob having a fire-polished front face facing said feeder and having a peripheral surface formed by contacting an inner surface of said casting mold;
cooling said gob within said mold;
removing said gob from said mold.

2. The process of claim 1, wherein said glass melt is filled into a cylindrical casting mold having a flattening at one inner surface thereof.

3. The process of claim 1, wherein said glass melt is filled into a casting mold made is of made of titanium.

4. The process of claim 1, wherein said glass melt is filled into a mold made of a non-oxide ceramic.

5. The process of claim 4, wherein said glass melt is filled into a mold made of a carbide ceramic.

6. The process of claim 5, wherein said glass melt is filled into a mold consisting of a carbide ceramic selected from the group formed by a silicon carbide ceramic, a boron carbide ceramic and a tungsten carbide ceramic.

7. The process of claim 1, further comprising the step of controlling a shape of the mold and controlling an activation of the glass scissors so as to yield a gob within said mold having a height to diameter ratio between 0.3 and 3.

8. The process of claim 1, further comprising the step of controlling a shape of the mold and controlling an activation of the glass scissors so as to yield a gob within said mold having a height to diameter ratio between 0.5 to 2.

9. The process of claim 1, further comprising the step of controlling a shape of the mold and controlling an activation of the glass scissors so as to yield a gob within said mold having a height to diameter ratio between 0.8 to 1.25.

10. The process of claim 1, further comprising the step of controlling a shape of the mold and controlling an activation of the glass scissors so as to yield a gob within said mold having a height to diameter ratio between 0.9 and 1.1.

11. The process of claim 1, wherein said step of providing a casting mold comprises preparing a casting mold by sintering.

12. The process of claim 1, wherein said step of proving a casting mold comprises the step of infiltrating a porous green body by molten silicon.

13. A gob made according to the method of claim 1.

14. A process of making a pressed glass product suitable for optical applications comprising the steps of:
providing a molten glass within a feeder;
providing a casting mold having a substantially cylindrical shape and made of an oxidation resistant material being substantially resistant against a glass melt and substantially free of sticking when in contact with a glass melt;
feeding a glass melt from said feeder into said casting mold;
cutting off the glass melt by means of glass scissors for portioning a gob within said casting mold, said gob having a fire-polished front face facing said feeder and having a peripheral surface formed by contacting an inner surface of said casting mold;
cooling said gob within said mold;
transferring said gob into a press mold;
positioning said gob within said press mold resting on a peripheral surface of said gob;
finish-pressing said gob within said press-mold so as to form a pressed glass product suitable for optical applications.

15. The process of claim 14, wherein said step of proving a casting mold comprises providing a cylindrical casting mold having a flattening at one inner surface thereof;
and wherein said step of placing said gob within said press mold comprises placing said gob within said press mold resting on a flattening formed by contacting said inner surface of said casting mold when feeding said glass melt into said casting mold.

16. The process of claim 14, wherein said gob is finish-pressed at its top side.

17. The process of claim 14, wherein said gob is finish-pressed at its bottom side.

18. The process of claim 14, wherein said gob is finish-pressed at its top and bottom sides.

19. The process of claim 14, wherein said step of proving a casting mold comprises providing a cylindrical casting mold made of a material selected from the group formed by titanium and a carbide ceramic.

20. The process of claim 14, wherein said step of proving a casting mold comprises providing a cylindrical casting mold made of a material selected from the group formed by a silicon carbide ceramic, a boron carbide ceramic and a tungsten carbide ceramic.
